(19) United States
(12) Patent Application Publication
(10) Pub. No.: US 2025/0002083 A1
(43) Pub. Date: Jan. 2, 2025

(54) TURNING CONTROLLER

(71) Applicant: DENSO CORPORATION, Kariya-city (JP)

(72) Inventors: TAKAFUMI SATO, Kariya-city (JP); SHUJI KURAMITSU, Kariya-city (JP); YUTA SUZUKI, Kariya-city (JP)

(21) Appl. No.: 18/883,826

(22) Filed: Sep. 12, 2024

Related U.S. Application Data
(63) Continuation of application No. PCT/JP2023/009362, filed on Mar. 10, 2023.

(30) Foreign Application Priority Data
Mar. 16, 2022 (JP) 2022-041511

(51) Int. Cl. B62D 7/15; B62D 6/00

(52) U.S. Cl. CPC B62D 7/159; B62D 6/002; B62D 7/1581

(57) ABSTRACT

A turning controller controls turning of each wheel in a vehicle having three or more wheels. The wheels are not mechanically constrained to each other and are turned independently. The turning controller includes turning actuator controllers provided in correspondence with turning actuators for turning each wheel. The turning actuator controllers control a driving current applied to the turning actuators so that a turning angle output by the turning actuator becomes a desired value. A set of a turning actuator and a turning actuator controller corresponding to each of the wheels is a unit. The turning actuator controllers communicates drive limit information, which is information regarding a drive limit of the turning actuator, with each other. The turning actuator controllers also limit a drive of the turning actuator of their own unit based on the drive limit information of their own unit and the other units.

### CROSS REFERENCE TO RELATED APPLICATIONS

The present application is a continuation application of International Patent Application No. PCT/JP2023/009362 filed on Mar. 10, 2023, which designated the U.S. and claims the benefit of priority from Japanese Patent Application No. 2022-041511 filed on Mar. 16, 2022. The entire disclosures of all of the above applications are incorporated herein by reference.

### TECHNICAL FIELD

The present disclosure relates to a turning controller.

### BACKGROUND

A steer-by-wire system switches a target turning angle of the other turned wheels in a case where a malfunction occurs in one of the turned wheels.

### SUMMARY

According to at least one embodiment, a turning controller controls turning of each wheel in a vehicle having three or more wheels. The wheels are not mechanically constrained to each other and are turned independently. The turning controller includes turning actuator controllers provided in correspondence with turning actuators for turning each wheel. The turning actuator controllers control a driving current applied to the turning actuators so that a turning angle output by the turning actuators becomes a desired value. A set of a turning actuator and a turning actuator controller corresponding to each of the wheels is a unit. The turning actuator controllers communicates drive limit information, which is information regarding a drive limit of the turning actuator, with each other. The turning actuator controllers also limit a drive of the turning actuator of their own unit based on the drive limit information of their own unit and the other units.

### BRIEF DESCRIPTION OF THE DRAWINGS

The details of one or more embodiments are set forth in the accompanying drawings and the description below. Other features and advantages will be apparent from the description and drawings, and from the claims.

The above and other objectives, features and advantages of the present disclosure will become more apparent from the following detailed description with reference to the accompanying drawings. In the drawings,

FIG. 1 is a schematic diagram of an independently turning vehicle to which a turning controller according to a first embodiment is applied;

FIG. 2 is a block diagram of a turning controller according to the first embodiment;

FIG. 3 is a diagram illustrating a relationship between a current limit value and a turning angle limit value;

FIG. 4 is a diagram illustrating an exemplary operation of a steering restriction by communication of driving restriction information between units;

FIG. 5A is an example showing a driving current vs. an actual turning angle map;

FIG. 5B is an example showing a current limit value vs. a turning angle limit value map;

FIG. 6 is a block diagram of a turning controller according to a second embodiment;

FIG. 7 is a diagram illustrating Ackermann theory;

FIG. 8A is a diagram for explaining determination of a common setting range of a turning center;

FIG. 8B is a diagram illustrating a change from a pre-limitation turning center to a post-limitation turning center;

FIG. 9 is a diagram illustrating an exemplary operation of a steering restriction by communication of driving restriction information between units; and

FIG. 10 is a block diagram of a turning controller according to a modification of the second embodiment.

### DETAILED DESCRIPTION

To begin with, examples of relevant techniques will be described.

A steer-by-wire system according to a comparative example switches a target turning angle of the other turned wheels in a case where a malfunction occurs in one of the turned wheels. For example, in a vehicle turning device of the comparative example, a target turning angle setting means calculates a limit turning angle according to a vehicle speed and a steering direction when one of the left and right turned wheels fails. The target turning angle setting means sets the limit turning angle as the target turning angle for the normally steered wheels when an absolute value of the turning angle of the normally turned wheels is greater than the absolute value of the calculated limit turning angle.

In the comparative example, a “failure of a turned wheel” refers to a case where normal turning angle control for the turned wheel cannot be performed, such as when a turning actuator can no longer generate turning torque. However, a driving electric current may be limited not only in a case of an abnormality in which the turning angle control function is completely lost, but also for reasons such as overheat protection when an excessive load is applied to any of the turning actuators. When the turning angle of some of the turned wheels is restricted, the vehicle may not move along a target trajectory, which may result in deterioration of vehicle controllability.

The comparative example targets vehicles in which only left and front right wheels are independently turned, and does not take into consideration vehicles with three or more independently turning vehicles, including four-wheel independently steering vehicles.

In contrast to the comparative example, according to a turning controller of the present disclosure, for an independently turning vehicle having three or more wheels, controllability of the vehicle can be appropriately ensured when one of the turning actuators is limited to driving.

According to one aspect of the present disclosure, a turning controller controls turning of each wheel in a vehicle having three or more wheels. The wheels are not mechanically constrained to each other and are turned independently. The turning controller includes turning actuator controllers provided in correspondence with turning actuators for turning each wheel. The turning actuator controllers control a driving current applied to the turning actuators so that a turning angle output by the turning actuators becomes a desired value. A set of a turning actuator and a turning actuator controller corresponding to each of the wheels is a unit. The turning actuator controllers communicates drive limit information, which is information regarding a drive limit of the turning actuator, with each other. The turning actuator controllers also limit a drive of the turning actuator of their own unit based on the drive limit information of their own unit and the other units.

According to this configuration, the turning actuator controllers cooperate to limit the drive of the turning actuators based on the drive limit information of each unit. Therefore, when the drive of any one of the turning actuators is limited, vehicle controllability can be appropriately ensured.

Several embodiments of a turning controller will be described with reference to the drawings. In the multiple embodiments, substantially the same components are denoted by the same reference numerals, and a description of the same components will be omitted. In the following description, first and second embodiments are collectively referred to as a present embodiment. The turning controller of the present embodiment controls a turning of each wheel in a vehicle in which four wheels that are not mechanically restricted from one another can be turned independently.

### First Embodiment

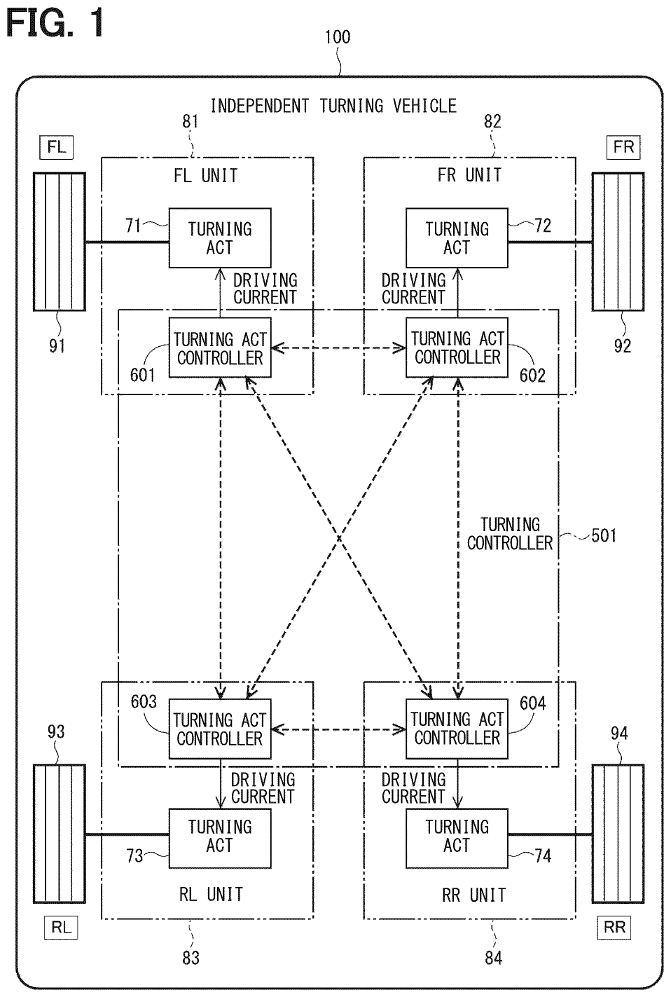

A turning controller 501 of a first embodiment will be described with reference to FIGS. 1 to 3. In an independently turning vehicle 100 shown in FIG. 1, the four wheels 91 to 94 are not mechanically constrained to one another and can be turned independently. A front left wheel 91 is defined as “FL”, a front right wheel 92 is defined as “FR”, a rear left wheel 93 is defined as “RL”, and a rear right wheel 94 is defined as “RR”. For example, each of the wheels 91 to 94 is a drive wheel equipped with an in-wheel motor, and can be independently turned and independently driven.

Four turning actuators 71 to 74 turn the wheels 91 to 94. For example, the turning actuators 71 to 74 of the present embodiment are configured with a dual-system three-phase brushless motor having two redundant winding sets. Four turning actuator controllers 601 to 604 are provided corresponding to the four turning actuators 71 to 74. The turning actuators 71 to 74 and the turning actuator controllers 601 to 604 are operated by receiving a power supply voltage from an in-vehicle battery (not shown).

The turning actuator controllers 601 to 604 control driving currents applied to the turning actuators 71 to 74 so that turning angles output by the turning actuators 71 to 74 become desired values. The turning angle is defined, for example, so that a left side is positive and a right side is negative with respect to a neutral position. The turning controller 501 includes these four turning actuator controllers 601 to 604.

A set of a turning actuator and a turning actuator controller corresponding to each of the wheels 91 to 94 is referred to as a unit. The turning actuator 71 and the turning actuator controller 601 constitute an FL unit 81 corresponding to the front left wheel 91. The turning actuator 72 and the turning actuator controller 602 constitute an FR unit 82 corresponding to the front right wheel 92. The turning actuator 73 and the turning actuator controller 603 constitute an RL unit 83 corresponding to the rear left wheel 93. The turning actuator 74 and the turning actuator controller 604 constitute an RR unit 84 corresponding to the rear right wheel 94.

Each unit may be configured as an electromechanically integrated turning module in which the turning actuator and the turning actuator controller are integrated together. In this case, the turning module may further be configured integrally with the wheels. Alternatively, each unit may have a separate turning actuator and a turning actuator controller electrically connected by wiring.

When drive of the wheels 91 to 94 is not limited, each turning actuator 71 to 74 can independently turn its corresponding wheel 91 to 94 in any direction. In other words, it is possible to generate a turning angle in a range of ±90 degrees with respect to the neutral position. However, when a wheel gets stuck in a rut or hits an obstacle while turning, an excessive load may be applied to one of the turning actuators. As a result, in some units, the driving current may be limited by an overheat protection function that reduces heat generation in elements and wiring components of the units due to overcurrent. Furthermore, when the power supply voltage drops, or when one of the turning actuators constituted by a dual-system motor is driven, the driving current is also limited.

Such information regarding the drive limit of the turning actuators 71 to 74 is referred to as “drive limit information”. In FIG. 1, both dashed arrows represent communication of the drive limit information between multiple turning actuator controllers 601 to 604. The turning actuator controllers 601 to 604 communicate the drive limit information to each other and limit the drive of the turning actuators 71 to 74 of its own unit based on the drive limit information of its own unit and the other units.

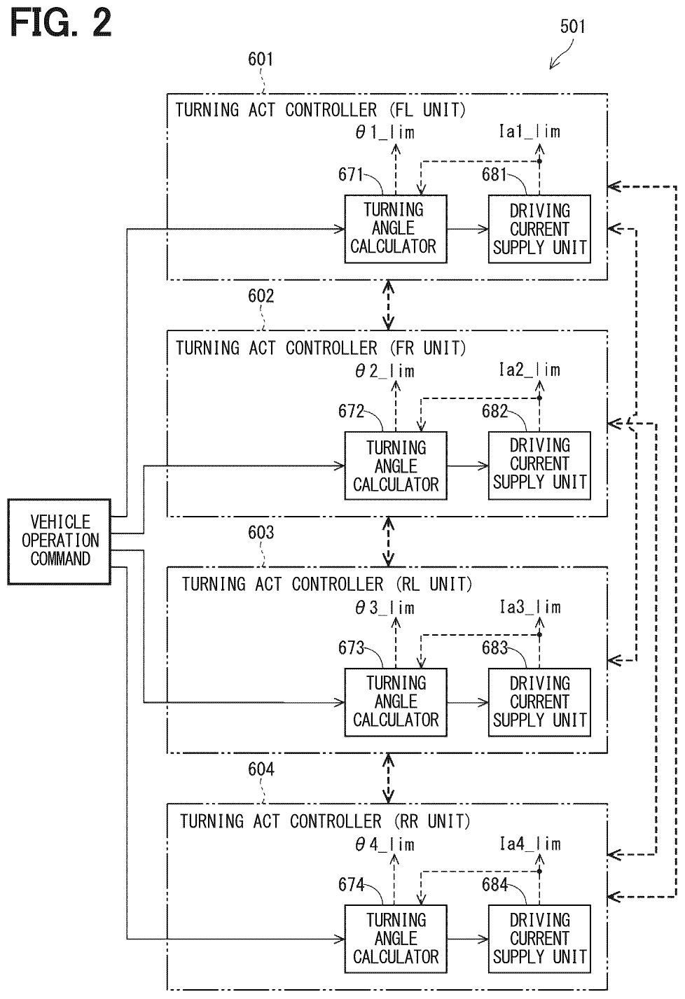

FIG. 2 shows a block diagram of the turning controller 501. The turning actuator controllers 601 to 604 of the respective units include turning angle calculators 671 to 674 and driving-current supply units 681 to 684. The turning angle calculators 671 to 674 receive vehicle operation commands indicating a vehicle operation to be realized from an outside, and calculate turning angle command values for the respective wheels 91 to 94 based on the vehicle operation commands.

For example, when a vehicle motion command instructing a left turn is received, the turning angle calculator 671 of the FL unit 81 and the turning angle calculator 672 of the FR unit 82 calculate a positive turning angle. When a vehicle motion command instructing a right turn is received, the turning angle calculator 671 of the FL unit 81 and the turning angle calculator 672 of the FR unit 82 calculate a negative turning angle.

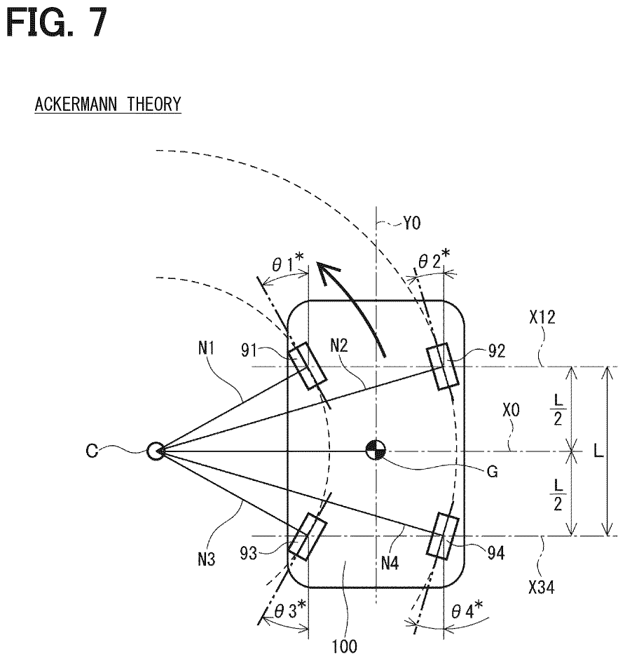

In a case of a turning operation in which the front wheels are turned according to parallel steering geometry, the turning angles of the left and front right wheels 91, 92 are set to be equal. In other words, a turning angle ratio of the turning angle of the wheels on an outside of the turn to the turning angle of the wheels on an inside of the turn is 1. In the following text, the term “turning angle ratio” is used in the above sense. In a case of a turning operation in which the front wheels are turned according to Ackermann steering geometry, an absolute value of the turning angle of the wheels on the inside of the turn is set to be larger than an absolute value of the turning angle of the wheels on the outside of the turn. In other words, the turning angle ratio in the turning operation according to Ackermann theory is a value smaller than 1. Ackermann theory will be described later in a second embodiment with reference to FIG. 7. In a turning operation intermediate between the parallel steering geometry and the Ackermann steering geometry, the turning angle ratio is a value larger than the turning angle ratio of Ackermann theory and smaller than 1.

The driving-current supply units 681 to 684 calculate and supply driving currents to be energized to the turning actuators 71 to 74 in accordance with the turning angle command values calculated by the turning angle calculators 671 to 674. For example, an inverter that converts DC power from a battery into three-phase AC power is included in the driving-current supply unit. Furthermore, the driving-current supply units 681 to 684 have a function of limiting the driving current that they calculate based on overheat protection information, power supply voltage drop information, one-system drive information, and the like.

The current limit values of the driving currents in the driving-current supply units 681 to 684 of each unit are denoted as la1_lim to la4_lim. The current limit value may be defined as any of a dq axis current, a phase current, and an effective value. Further, the turning angle limit value corresponding to the current limit value la1_lim tola4_lim is denoted as θ1_lim to θ4_lim. The turning angle limit value is expressed as a positive value as a limit value for the absolute value of the turning angle, regardless of whether the turning angle is positive or negative, i.e., regardless of whether the turning angle is left or right.

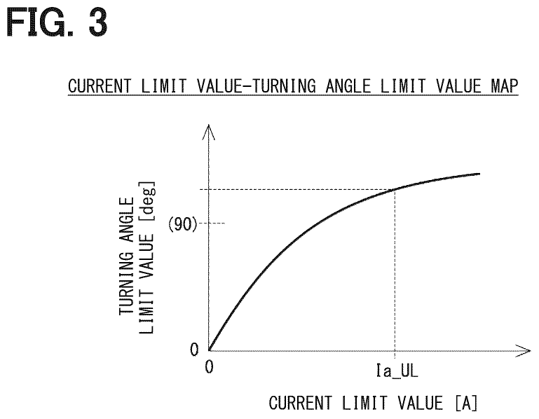

As shown in FIG. 3, there is a positive correlation between the current limit value and the turning angle limit value. The current limit value equivalent to the turning angle limit value of 90 degrees plus a margin becomes a substantial limit upper limit value la_UL. When the current limit value is not limited, for example, the current limit value may be set to a value larger than the limit upper limit value la_UL. Alternatively, a presence or absence of a current limit may be determined by a flag.

The turning angle calculators 671 to 674 of each unit calculate a turning angle command value so that the absolute value of the turning angle command value according to a turning direction is equal to or less than the turning angle limit value θ1_lim to θ4_lim. For example, when the turning angle limit value is 15 degrees, the turning angle calculators 671 to 674 calculate the turning angle command value in a range of 0 to +15 degrees for a left turn and in a range of −15 to 0 degrees for a right turn.

As in FIG. 1, dashed double-headed arrows in FIG. 2 indicate communication of the drive limit information. In the first embodiment, the current limit value la1_lim to la4_lim of the driving current of each of the turning actuators 71 to 74 or the turning angle limit value θ1_lim to θ4_lim is communicated between the units as the drive limit information. In the first embodiment, both the current limit value and the turning angle limit value may be communicated between the units as the drive limit information.

When the drive limit information is the current limit value la1_lim to la4_lim of the driving current of each unit, the turning actuator controllers 601 to 604 of each unit limit the driving current of its own unit to less than a minimum of the current limit values of all the units.

When the drive limit information is the turning angle limit value θ1_lim to θ4_lim, the turning actuator controllers 601 to 604 of each unit limit the driving current of its own unit to, for example, less than the minimum of the current limit values of all the units. When the absolute values of the turning angle command values of the left and right units are both set equal to the minimum value of the turning angle limit values, a turning operation according to the parallel steering geometry is realized.

Alternatively, a correction calculation for the turning angle is specified among units, and a corrected turning angle limit value may be calculated by performing the correction calculation for the minimum value of the turning angle limit values of all the units. The turning actuator controller 601 to 604 of each unit limits the absolute value of the turning angle command value of its own unit to less than “the corrected turning angle limit value after performing the correction calculation on the minimum value of the turning angle limit values of all units”.

For example, it is assumed that a correction turning angle ratio (<1) corresponding to the vehicle speed etc. is defined between the left and right units on the inside and outside of a turn, and a calculation of multiplication and division of the correction turning angle ratio is performed. The absolute value of the turning angle command value of the unit on the outside of the turn is limited to a corrected turning angle limit value which is smaller than the minimum turning angle limit value when the turning angle limit value of the unit on the inside of the turn is the minimum value. The absolute value of the turning angle command value of the unit on the inside of the turn is limited to a corrected turning angle limit value which is greater than the minimum turning angle limit value when the turning angle limit value of the unit on the outside of the turn is the minimum value.

According to this configuration, degree of freedom is improved to realize a turning operation according to Ackermann steering geometry or a turning operation intermediate between the parallel steering geometry and Ackermann steering geometry. The calculation is not limited to multiplication and division of the correction turning angle ratio between the left and right units, but a correction calculation for adding or subtracting an offset angle may be performed.

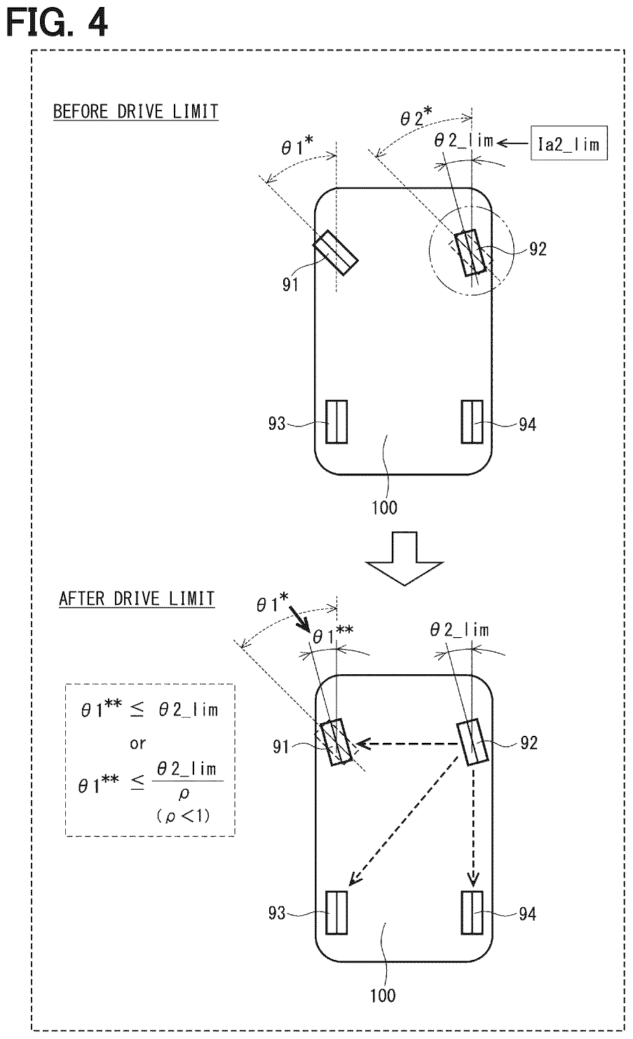

An exemplary operation of a steering restriction by communication of the drive limit information including between units in the first embodiment will be described with reference to FIG. 4. In the exemplary operation of FIG. 4, the driving current in the FR unit corresponding to the front right wheel 92 is limited to a current limit value la2_lim. The absolute value of the turning angle command value of the FR unit is limited to the turning angle limit value θ2_lim. For ease of explanation, it is assumed that the rear wheels 93, 94 remain in the neutral position and are not turned, and only the front wheels 91, 92 are turned to turn left.

Before the drive limit, the turning angle command value θ1* for the front left wheel 91 and the turning angle command value θ2* for the front right wheel 92 are calculated based on a vehicle operation to be realized. An imaginary state in which the front right wheel 92 is steered according to the command value θ2* is shown by a dashed line in FIG. 4. However, based on the turning angle limit value θ2_lim of the FR unit, a state indicated by a solid line becomes the limit turning angle of the front right wheel 92. When the vehicle 100 were to turn in this state, that is, with the front left wheel 91 not being restricted from turning and only the front right wheel 92 being restricted from turning, the vehicle 100 would be in an uncontrollable state.

In order to avoid the uncontrollable state, the current limit value la2_lim or the turning angle limit value θ2_lim is communicated as drive limit information from the turning actuator controller of the FR unit to the turning actuator controller of other F, RL, and RR units. The turning actuator controller of the FL unit limits the driving current of its own unit to the current limit value la2_lim or less. Alternatively, the turning actuator controller of the FL unit limits the absolute value of the turning angle command value of its own unit to be less than or equal to θ2_lim, or to be less than or equal to the corrected turning angle limit value (θ2_lim/ρ) obtained by performing the correction calculation using the correction turning angle ratio ρ, for example. The turning angle command value of the FL unit after the drive limit is denoted as θ1**.

As a result, the turning angle of the front left wheel 91 is limited to be equal to or less than the turning angle of the front right wheel 92. Since the turning angle command values of the RL unit and the RR unit corresponding to the left and rear right wheels 93, 94 are originally 0 deg, there is no influence of the drive limit information. In this manner, in the present embodiment, when the driving current of the turning actuator is limited in some units, the units change the turning angle command value within the limited range in cooperation with each other. Therefore, vehicle controllability is ensured, and the vehicle 100 can achieve stable turning operations.

Here, when the characteristics of the current limit value and the turning angle limit value in each unit are the same, there is no substantial difference no matter which is communicated as the drive limit information. However, in cases where there are differences in the characteristics of the current limit value and the turning angle limit value for each unit, communicating the turning angle limit value as drive limit information makes it possible to directly limit the turning angle of each unit in a balanced manner.

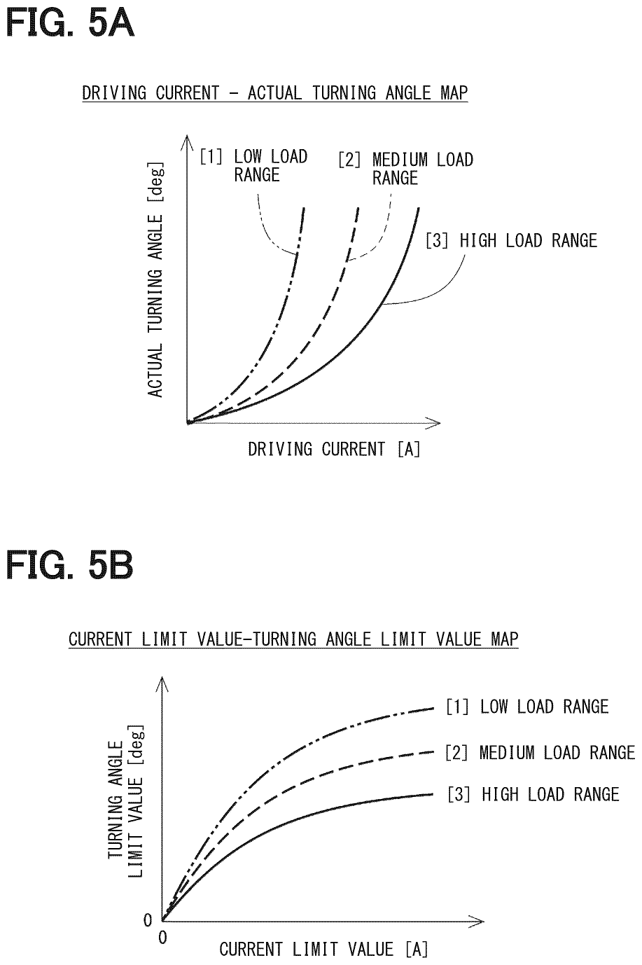

Incidentally, the characteristics of the actual turning angle with respect to the driving current differ depending on road surface conditions such as road surface friction coefficients and unevenness, and the characteristics of the turning angle limit value with respect to the current limit value also change. Next, calculation of the turning angle limit value that reflects the road surface conditions will be described with reference to FIGS. 5A and 5B.

Each of the turning actuator controllers 601 to 604 stores the driving current vs. actual turning angle map shown in FIG. 5A and the current limit value vs. turning angle limit value map shown in FIG. 5B. Here, the term “map” is not limited to a large number of data groups stored in a readable manner, but also includes calculation formulas. In other words, outputting the calculation result of a formula based on input variables is also considered to be one form of calculation using a map.

The driving current vs. actual turning angle map defines the actual turning angle of the wheels 91 to 94 relative to the driving current of the turning actuators 71 to 74 for one or more load ranges divided according to magnitude of the load. Relatively, the load range is divided into [1] a low load range, [2] a medium load range, and [3] a high load range. In the low load range, a large actual turning angle is generated with a relatively small driving current, whereas in the high load range, a larger driving current is required to generate the same degree of actual turning angle.

The current limit value vs. turning angle limit value map defines a relationship between the current limit value of the driving current for the turning actuators 71 to 74 and the turning angle limit value for each load range. In a case where the current limit values are same, the turning angle limit value in the low load range is greater than the turning angle limit value in the high load range.

Each turning actuator controller 601 to 604 may calculate the actual turning angle based on rotation angle detection values of the turning actuators 71 to 74, for example, or may obtain the actual turning angle from a turning angle sensor provided on the wheels 91 to 94. The turning actuator controllers 601 to 604 determine the load range based on the driving current flowing through the turning actuators 71 to 74 and the detected actual turning angle, using the driving current vs. actual turning angle map.

Then, the turning actuator controllers 601 to 604 calculate the turning angle limit value corresponding to the current limit value in the determined load range, using the current limit value vs. turning angle limit value map. According to this configuration, it is possible to appropriately set the turning angle limit values for each of the wheels 91 to 94 according to the road surface conditions.

### Second Embodiment

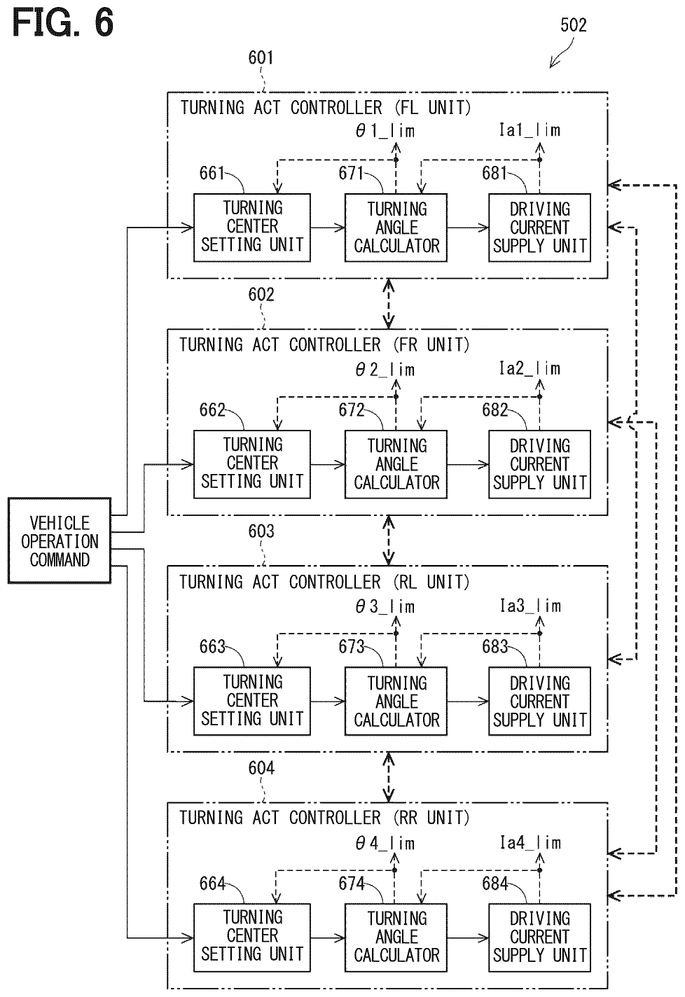

A second embodiment will be described with reference to FIGS. 6 to 9. As shown in FIG. 6, in contrast to the first embodiment, in a turning controller 502 of the second embodiment, a turning angle command value for each unit is calculated after setting of a turning center based on a vehicle operation command. In a configuration example shown in FIG. 6, the turning-center setting units 661 to 664 are provided inside the turning actuator controllers 601 to 604 of the respective units. The turning angle calculators 671 to 674 calculate the turning angle command values based on the turning centers set by the turning-center setting units 661 to 664. Furthermore, the turning angle calculators 671 to 674 notify the turning angle limit values θ1_lim to θ4_lim to the turning-center setting units 661 to 664.

A calculation of the turning angle command values θ1* to θ4* based on Ackermann theory will be described with reference to FIG. 7. According to Ackermann theory, the turning direction of each of the wheels 91 to 94 is perpendicular to straight lines N1 to N4 connecting the turning center C and the center of each of the wheels 91 to 94. That is, each of the wheels 91 to 94 is steered in the tangent direction of a circle having the turning center C as its center.

An axis passing through the centers of the front wheels 91, 92 and perpendicular to a vehicle longitudinal axis Y0 is defined as a front wheel axis X12, and an axis passing through the centers of the rear wheels 93, 94 and perpendicular to the vehicle longitudinal axis Y0 is defined as a rear wheel axis X34. The distance between the front wheel axis X12 and the rear wheel axis X34 is a wheelbase L. Further, an axis passing through the center of gravity G and perpendicular to the vehicle longitudinal axis Y0 is represented as a gravity axis X0. Assuming that weight distribution in a vehicle front-rear direction is uniform, the gravity axis X0 is located midway between the front wheel axis X12 and the rear wheel axis X34. When the turning center C is set on the gravity axis X0, the front left wheel 91 and the rear left wheel 93, and the front right wheel 92 and the rear right wheel 94 each turn on the same arc, so that an inner wheel difference and an outer wheel difference become zero and a running resistance during turning becomes small.

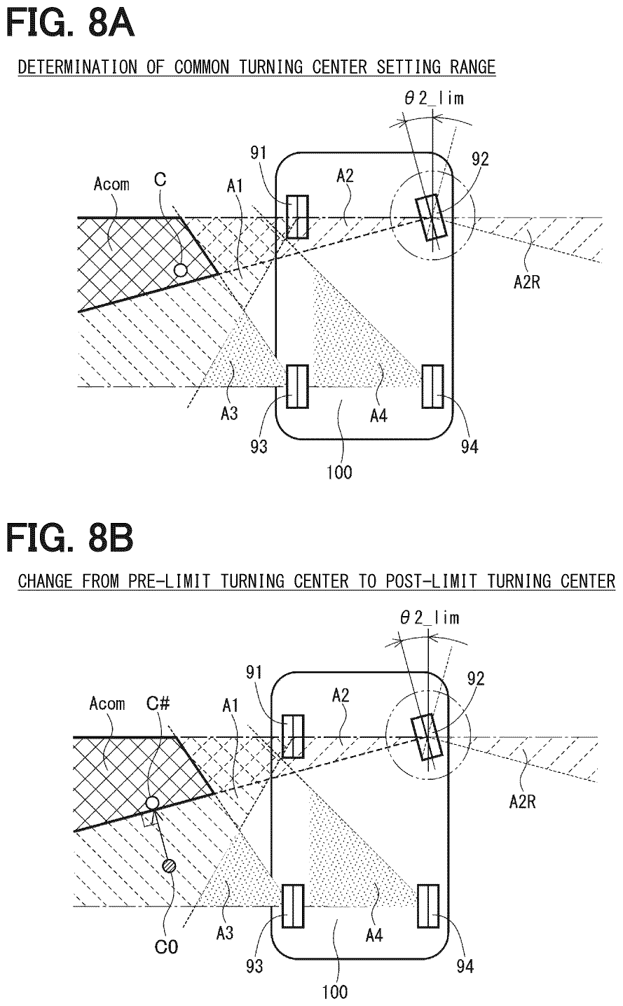

Referring to FIG. 8A, setting of the turning center C by the turning-center setting units 661 to 664 will be described. The turning angle range permitted for each of the wheels 91 to 94 is determined according to the turning angle limit value θ1_lim to θ4_lim of each unit. A range obtained by rotating this turning angle range 90 degrees toward the turning center C becomes turning center setting ranges A1 to A4 of each unit.

FIG. 8A shows an example of a left turn in which the turning angle limit value θ2_lim of the front right wheel 92 is smaller than the turning angle limit values of the other wheels 91, 93, and 94. The turning center setting range A2R for the front right wheel 92 turning to the right is symmetrical to a turning center setting range A2. Moreover, the ranges of a matte hatching for the turning center setting ranges A3, A4 of the rear wheels 93, 94 are omitted halfway.

The turning center setting ranges A1 to A4 are communicated between the units as drive limit information. A range where the turning center setting ranges A1 to A4 of units overlap with each other (a cross-hatched range in FIG. 8A) is defined as a common setting range Acom. The turning-center setting units 661 to 664 of each unit set the turning center C within the common setting range Acom. The turning angle calculators 671 to 674 calculate the turning angle command values θ1* to θ4* based on the turning center C.

In the second embodiment, the turning center setting range A1 to A4, which is set in accordance with the turning angle limit value θ1_lim to θ4_lim of each unit, is used as drive limit information, and the turning actuator controllers 601 to 604 cooperate to limit the drive of the turning actuators 71 to 74. Therefore, the turning angle ratio according to Ackermann theory can reduce the running resistance during turning while ensuring appropriate vehicle controllability. Furthermore, since the turning-center setting units 661 to 664 are provided separately for each unit, it is possible to avoid risks of the turning center setting function failing all at once for all the units.

Next, referring to FIG. 8B, a description will be given of changing the turning center when a pre-limitation turning center C0 set based on the vehicle operation to be realized is outside the common setting range Acom. In this case, the turning-center setting units 661 to 664 set a position in the common setting range Acom at which a distance from the pre-limitation turning center C0 is minimum as a post-limitation turning center C #. This makes it possible to minimize deviation from the desired vehicle turning operation while ensuring appropriate vehicle controllability.

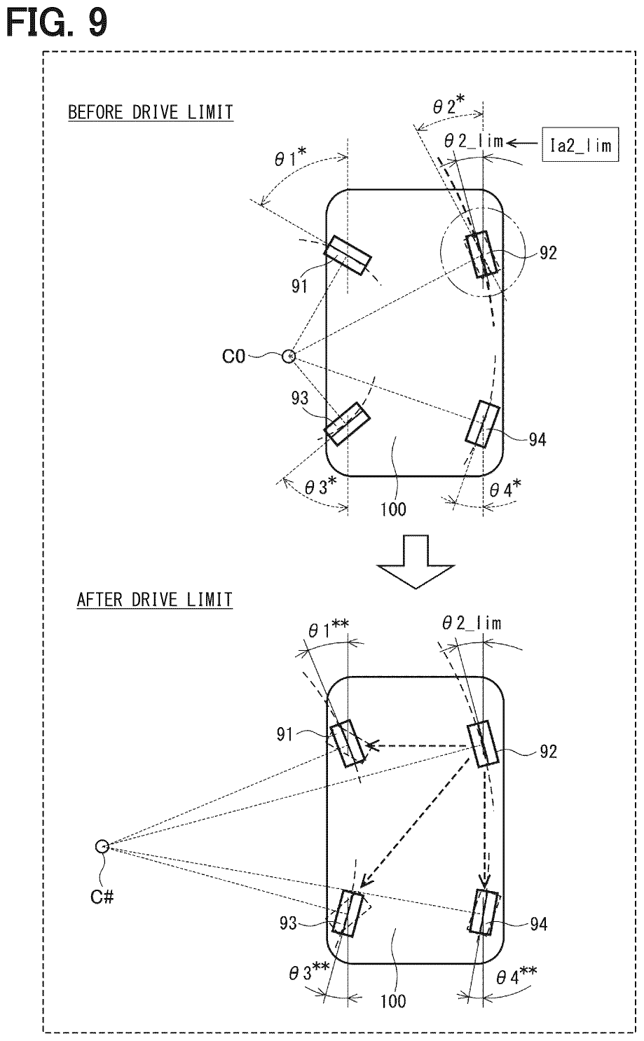

An exemplary operation of a steering restriction by communication of the drive limit information including between units in the second embodiment will be described with reference to FIG. 9. In contrast to the exemplary operation of the first embodiment shown in FIG. 4, the exemplary operation of FIG. 9 assumes a situation in which, when drive is limited by the FR unit, the four wheels 91 to 94 are turned independently in accordance with Ackermann steering geometry to make a left turn. In order to make it easier to see a difference before and after drive restriction, the example is shown in which the post-limitation turning center C # is changed to a position relatively far away from the pre-limitation turning center C0, regardless of the method in FIG. 8B.

Before the drive limit, the turning angle command values θ1* to θ4* for the wheels 91 to 94 are calculated using the turning center C0 which is set based on the vehicle operation to be realized. An imaginary state in which the front right wheel 92 is steered according to the command value θ2* is shown by a dashed line in FIG. 9. However, based on the turning angle limit value θ2_lim of the FR unit, a state indicated by a solid line becomes the limit turning angle of the front right wheel 92. When the vehicle 100 were to turn in this state, that is, with only the front right wheel 92 restricted from turning while the other wheels 91, 93, 94 are not restricted from turning, the vehicle 100 would be in an uncontrollable state.

In order to avoid the uncontrollable state, the turning center setting range determined according to the turning angle limit value θ2_lim as drive limit information from the turning actuator controller of the FR unit to the turning actuator controller of other F, RL, and RR units. The turning actuator controllers of the FL, RL and RR units communicate with each other and set the turning center after limit C # within the common setting range of all the units. Then, the turning actuator controllers of the FL, RL, and RR units calculate the turning angle command values θ1**, θ3**, θ4** of their own units after the drive limit.

As a result, the turning angle command values of all units are reset according to the Ackermann geometry using the turning center after limit C # in accordance with the turning angle limit value θ2_lim of the FR unit. Therefore, even if the driving current of the turning actuator in some units is limited, vehicle controllability is ensured, and the vehicle 100 can achieve stable turning operation.

### Modification of Second Embodiment

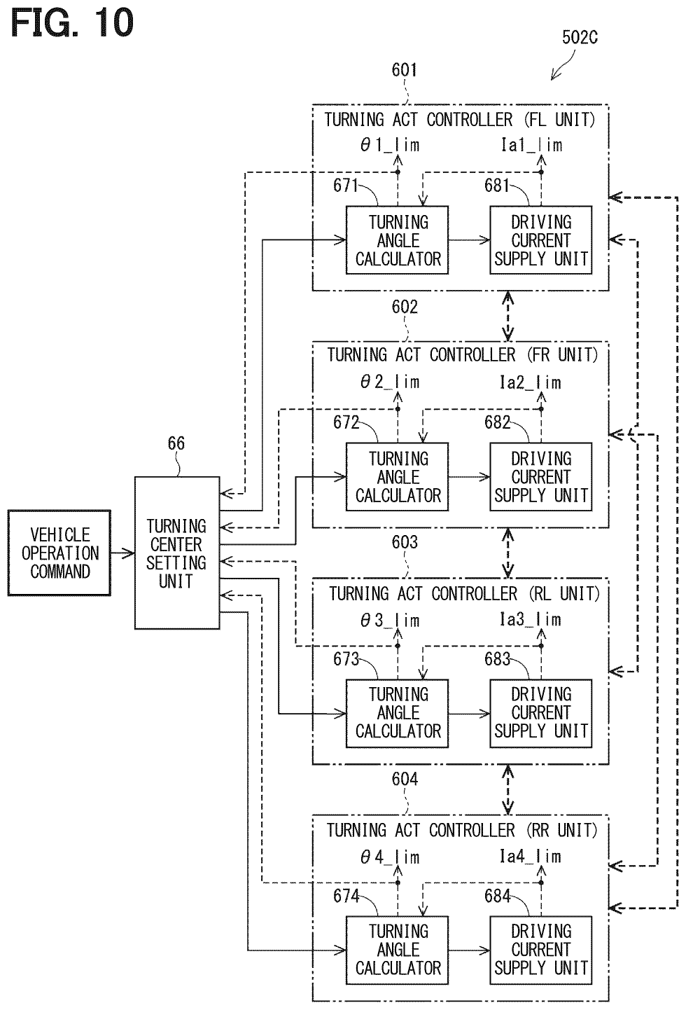

As shown in FIG. 10, in a turning controller 502C according to a modification of the second embodiment, one turning-center setting unit 66 is provided in common to the turning actuator controllers 601 to 604 of the respective units. In other words, the turning-center setting unit 66 is provided outside the turning actuator controllers 601 to 604 of each unit.

The turning-center setting unit 66 sets the turning center C based on the vehicle operation to be realized, and issues a command to the turning angle calculators 671 to 674 of each unit. Furthermore, the turning-center setting unit 66 determines a common setting range based on the turning angle limit values θ1_lim to θ4_lim notified from the turning angle calculators 671 to 674 of the respective units. With this configuration, the same actions and effects as those of the second embodiment can be obtained. Furthermore, by consolidating the turning center setting functions into one turning-center setting unit 66, efficient calculations are possible.

### OTHER EMBODIMENTS

The turning controller of the present disclosure is not limited to four-wheel vehicles, but can also be applied to three-wheel vehicles, or six-wheel or eight-wheel independently steering vehicles having three or more rows of left and right wheel pairs in the longitudinal direction of the vehicle. In summary, the turning controller of the present disclosure is applied to “a vehicle in which three or more wheels that are not mechanically restrained from one another can be steered independently.”

The turning actuators 71 to 74 are not limited to dual-system three-phase brushless motors, and may be configured as single-system polyphase motors, DC motors, linear actuators, or the like.

Each of the wheels 91 to 94 need only be capable of being turned independently and does not have to be driven independently. For example, front wheels 91, 92 may be drive wheels, and rear wheels 93, 94 may be driven wheels.

The present disclosure should not be limited to the embodiment described above. Various other embodiments may be implemented without departing from the scope of the present disclosure.

The controller and the method according to the present disclosure may be implemented by a dedicated computer provided by constituting a processor and a memory programmed to execute one or more functions embodied by a computer program. Alternatively, the controller described in the present disclosure and the method thereof may be implemented by a dedicated computer configured as a processor with one or more dedicated hardware logic circuits. Alternatively, the controller and the method described in the present disclosure may be realized by one or more dedicated computer, which is configured as a combination of a processor and a memory, which are programmed to perform one or more functions, and a processor which is configured with one or more hardware logic circuits. The computer program may be stored in a computer-readable non-transitory tangible storage medium as an instruction executed by a computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A turning controller configured to control turning of each wheel in a vehicle having three or more wheels which are not mechanically constrained to each other and are turned independently, the turning controller comprising
turning actuator controllers provided in correspondence with turning actuators for turning each wheel, and configured to control a driving current applied to the turning actuators so that a turning angle output by the turning actuators becomes a desired value, wherein
a set of a turning actuator and a turning actuator controller corresponding to each of the wheels is a unit,
the turning actuator controllers are configured to:
communicate drive limit information, which is information regarding a drive limit of the turning actuator, with each other; and
limit a drive of the turning actuator of own unit based on the drive limit information of the own unit and the other units.

2. The turning controller according to claim 1, wherein
the drive limit information is a current limit value of the driving current of each unit, and
the turning actuator controller of each unit is configured to limit the driving current of the own unit to be less than or equal to a minimum value of the current limit value of all units.

3. The turning controller according to claim 1, wherein
the drive limit information is a turning angle limit value of each unit, and
the turning actuator controller of each unit is configured to limit an absolute value of a turning angle command value of the own unit to be less than or equal to a minimum value of the turning angle limit value of all units, or to be less than or equal to a corrected turning angle limit value obtained by performing a correction calculation defined among units with respect to the minimum value.

4. The turning controller according to claim 1, wherein
the turning actuator controller of each unit is configured to calculate a turning angle command value for each wheel so that a turning direction of each wheel is perpendicular to a line connecting a turning center, which is set based on a vehicle operation to be realized, and a center of each wheel,
the drive limit information is a turning center setting range corresponding to a turning angle range of each wheel permitted according to a turning angle limit value of each unit, and
the turning actuator controller of each unit is configured to:
set a turning center in a common setting range in which the turning center setting ranges of the units overlap with each other; and
calculate the turning angle command value of the own unit.

5. The turning controller according to claim 4, wherein
the turning actuator controller of each unit is configured to set a position, at which a distance from a pre-limitation turning center is smallest in the common setting range, as a post-limitation turning center when the pre-limitation turning center, which is set based on a vehicle operation, to be realized is outside the common setting range.

6. The turning controller according to claim 3, wherein
the turning actuator controller is configured to:
store a first map, which specifies a relationship between the driving current of the turning actuator and an actual turning angle of the wheel, for each of one or more load ranges, which are divided according to a magnitude of a load, and a second map, which specifies a relationship between a current limit value of the driving current of the turning actuator and the turning angle limit value, for each of the one or more load ranges;
determine a load range of the load ranges using the first map based on the driving current applied to the turning actuator and a detected actual turning angle; and
calculate the turning angle limit value corresponding to the current limit value in the determined load range using the second map.

7. A turning controller configured to control turning of each wheel in a vehicle having three or more wheels which are not mechanically constrained to each other and are turned independently, the vehicle having turning actuators for turning each wheel, the turning controller comprising:
at least one processor configured to control a driving current applied to the turning actuators so that a turning angle output by the turning actuators becomes a desired value; and
at least one memory storing computer program code, wherein
the at least one memory and the computer program code are configured, with the at least one processor, to cause the turning controller to carry out limiting a drive of the turning actuators based on drive limit information, which is information regarding a drive limit of the turning actuators.
